(19) United States
(12) Patent Application Publication
(10) Pub. No.: US 2007/0261825 A1
(43) Pub. Date: Nov. 15, 2007

(54) Method for Fixing a Thermal Screen to a Plastic Part and Thermal Screen Thus Adapted

(75) Inventors: Jean-Pierre Jsan, Lamorlaye (FR); Fabrice Dumont, Compiegne (FR)

Correspondence Address: YOUNG & THOMPSON, 745 SOUTH 23RD STREET, 2ND FLOOR, ARLINGTON, VA, 22202, US

(73) Assignee: Federal Mogul Systems Protection Group, Crepy-En-Valois (FR)

(21) Appl. No.: 11/665,536

(22) PCT Filed: Oct. 11, 2005
(86) PCT No.: PCT/FR05/02513

§ 371 Date: Apr. 17, 2007

(30) Foreign Application Priority Data
Oct. 18, 2004 (FR) 0411003

(51) Int. Cl. F16L 59/02

(52) U.S. Cl. 165/135; 29/235

(57) ABSTRACT

A method for fixing a thermal screen (10) onto a plastic part (20). The thermal screen comprises a layer made of a reflecting thermally conducting material and a layer made of a thermally insulating material, placed opposite each other on the plastic part. The method comprises a step in which the thermal screen is vibrationally welded onto the plastic part. Use: protection of a fuel tank.

The present invention concerns a method for fixing a thermal screen to a plastic part.

It also concerns a thermal screen for a plastic part adapted to be fixed by the fixing method according to the invention.

The invention is generally concerned with the field of the thermal protection of plastic parts, and is aimed more particularly at the thermal protection of a fuel tank of an automobile vehicle.

A thermal screen is used to protect a plastic element from the radiation from the surrounding elements, such as an exhaust pipe, for example, the temperature whereof can reach 600°.

A fuel tank is made of plastic material of the polyethylene type and must be kept at a temperature less than 80° C.

A rigid metal, for example aluminum, thermal screen is conventionally used. That rigid screen is disposed at a distance from the fuel tank and thus forms a shell around the tank.

This type of thermal screen is fixed to the tank with the aid of screws. It is then necessary to provide during the fabrication of the tank elements for fixing this thermal screen to the tank.

These fixing points constitute points of weakness.

What is more, the thermal screen in the form of a shell is heavy, and may generate noise through vibration.

Finally, this thermal screen must be disposed at a distance from the surface of the tank, with the result that it is bulky and generates a loss of usable volume of the fuel tank.

An object of the present invention is to remove the drawbacks cited above and to propose a new method for fixing a thermal screen and an associated thermal screen for protecting a plastic part.

To this end, the present invention is aimed at a method for fixing a thermal screen to a plastic part, the thermal screen comprising a reflective and thermally conductive material layer and a thermally insulative material layer intended to be placed opposite the plastic part.

According to the invention this fixing method comprises a step of welding the thermal screen to the plastic part using a vibrational technology.

Thus the Applicant has discovered that it was possible to use vibrational technology welding to fix a thermal screen to a plastic part despite the presence of a layer of reflecting material.

This technology enables the use of a relatively flexible thermal screen that can be conformed optimally to the shape of the plastic part to be protected.

This limits the space necessary for placement of the thermal screen. In practice, a vibrating head generating heat is applied in at least one area of the layer of reflective and thermally conductive material.

Thanks to the heating caused by the vibrating head, it is possible to obtain, through the thermally conductive material, the melting of the plastic part and possibly of the layer of thermally insulative material. After cooling, these materials are joined at the level of the spot weld.

The vibrating head is advantageously an ultrasound head the vibration frequency whereof is from 20 to 40 kiloHertz.

The present invention is also aimed at protecting a thermal screen for a plastic part comprising a layer of reflective and thermally conductive material and a layer of thermally insulative material, adapted to be fixed by a fixing method according to the invention.

Such a thermal screen has the advantage that it can be fixed to any type of plastic part without requiring particular preparation of the plastic part beforehand.

The invention also concerns a thermal screen for plastic part, comprising a reflective and thermally conductive material layer and a thermally insulative material layer, this thermal screen comprising at least one marking area adapted to identify an area of vibrational technology welding of the thermal screen to a plastic part.

Thus locations can be made apparent, by a marking, for example by stamping, that thereafter correspond to the welding areas during the fixing of the thermal screen to the plastic part.

By identifying the spot welds of the thermal screen to the tank in this way, it is advantageously therefore possible to position the spot welds relative to the sources of thermal radiation to which the plastic part to be protected is exposed.

Other features and advantages of the invention will become further apparent in the following description.

In the appended drawings, given by way of nonlimiting example:

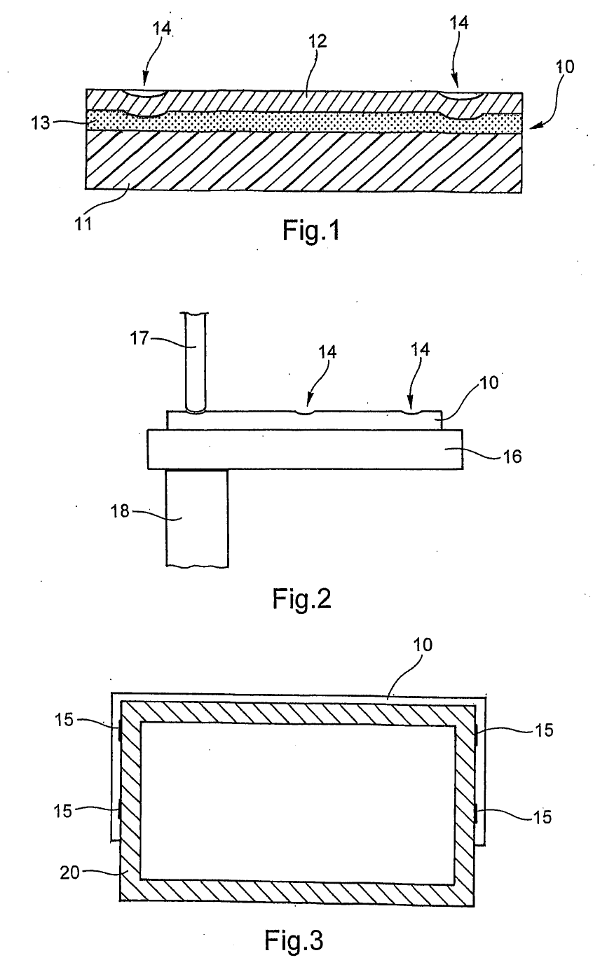

FIG. 1 is a diagrammatic view in section of a thermal screen according to one embodiment of the invention;

FIG. 2 is a diagrammatic view showing the method for fixing a thermal screen according to the invention; and

FIG. 3 is a view in cross section showing the fixing of a thermal screen to a fuel tank.

There will first be described with reference to FIG. 1 a thermal screen for a plastic part according to one embodiment of the invention.

This thermal screen 10 consists of a multilayer structure.

It includes firstly a layer 11 of thermally insulative material intended to face the plastic part to be protected.

This thermally insulative material layer 11 has a thickness from 1 to 30 millimeters and preferably from 2 to 15 millimeters.

This thermally insulative material may be a thermally insulative textile.

A layer of non-woven polyester is used, for example.

Any thermoplastic material may be suitable, for example a polyethylene type textile.

A mineral material may be used where appropriate, of the single glass fiber layer type.

The thermal screen further includes a layer 12 of a reflective and thermally conductive material.

That reflective material layer is intended to protect the plastic part from thermal radiation.

A layer of aluminum may be used, for example.

This reflective and thermally conductive material layer 12 preferably has a thickness from 1 micrometer to 1 millimeter and preferably from 25 to 500 micrometers.

Because of this relatively small thickness of aluminum, the thermal screen according to the invention takes the form of a semi-rigid multilayer product.

The thickness of the aluminum layer has no direct impact on its thermal reflection properties.

It must nevertheless be sufficient to resist thrown up loose chippings, in particular in the case of applications of this thermal screen to a fuel tank of an automobile vehicle.

These two layers 11, 12 are joined by a conventional system and by a glue or an adhesive 13, for example.

This thermal screen 10 may preferably include at least one marking area, two marking areas 14 in the example shown in FIG. 1, for identifying an area of vibrational technology welding of the thermal screen to a plastic part.

These marking areas 14 may correspond to areas lightly stamped in the reflective and thermally conductive material layer 12 of the thermal screen 10.

The places at which the thermal screen will be spot welded to a plastic part can therefore be planned in advance.

A method for fixing a thermal screen 10 as described hereinabove to a plastic part 16 will be described now with reference to FIG. 2.

By way of example, this plastic part 16 may constitute a fuel tank and be made of polyethylene, for example.

To effect this fixing, the thermal screen is welded to the plastic part using vibrational technology welding.

In practice, this thermal screen 10 is disposed so that the thermally insulative material layer 11 is in contact with the plastic part 16 to be protected.

A vibrating head 17 generating heat is then applied. This vibrating head is applied to at least one point of the reflective and thermally conductive material layer 12.

This vibrating head 12 is preferably applied to a predetermined marking area 14 in the thermal screen, as shown in FIG. 2.

In this embodiment, ultrasound welding is used, the vibrating head having a vibration frequency from 20 to 40 kiloHertz.

High-frequency welding could also be used.

The principle of an ultrasound head is that it is caused to vibrate, this vibration causing the heating of the head.

This head 17 is applied with a certain pressure to the thermal screen 10 in contact with the plastic part 16, a counter-tool 18 being disposed in contact with the plastic part 16 in line with the vibrating head 17.

Despite the presence of the aluminum layer 12, the plastic material 16 and where applicable the layer of thermally insulative material 11 melt(s) at the level of the spot weld 15.

On cooling, these two materials are joined at the spot weld 15.

It will be noted that if a glass fiber layer 11 is used, the melting point whereof is of the order of 1000° C., that glass fiber layer does not melt during the welding step. The plastic part 16 alone is softened sufficiently to enable the joining and the welding of this glass fiber layer 11 to the plastic part 16.

A contrario, if a non-woven polyester textile is used as the insulative layer 11, this has a melting point of about 250° C.

On application of the ultrasound welding head, both this polyester layer 11 and the plastic material 16 are softened, so that the joining by welding of the two components may be obtained thanks to the pressure exerted by the head 17 and the counter-tool 18.

This welding is obtained regardless of the thermoplastic material used in the thermally insulative material layer.

FIG. 3 shows by way of example the fixing by welding of a thermal screen 10 to a fuel tank 20.

It will be noted that it may be important to offset the spot welds 15 relative to the sources of thermal radiation to which the fuel tank 20 is exposed because these spot welds 15 necessarily constitute points of weakness for the reflection of thermal radiation.

Thanks to this method for fixing the thermal screen to a plastic part by the vibrational welding technology, it is no longer necessary to provide anchor points for a thermal screen on the tank when molding it.

Furthermore, the thermal screen being applied directly in contact with the tank, an important saving of space is obtained compared to the use of a rigid thermal screen in the form of a shell that cannot be conformed exactly to the exterior contour of the tank. Thus the usable volume of the fuel tank may be increased.

The thermal screen according to the invention furthermore saves weight compared to a rigid thermal screen and does not generate noise by vibration.

It is furthermore easy to modify the thermal screen to adapt to any type of fuel tank shapes.

Of course, the present invention is not limited to the examples described hereinabove.

In particular, the thermal screen according to the invention could be fixed to any type of plastic part, in multiple thermal protection applications.

1. Method for fixing a thermal screen (10) to a plastic part (16, 20), the thermal screen (10) comprising a reflective and thermally conductive material layer (12) and a thermally insulative material layer (11) adapted to be placed opposite said plastic part (16, 20), characterized in that it comprises a step of welding said thermal screen (10) to said plastic part (16, 20) using a vibrational technology.

2. Fixing method according to claim 1, characterized in that a vibrating head (17) generating heat is applied to at least one area (14) of the reflective and thermally conductive material layer (12).

3. Fixing method according to claim 2, characterized in that said vibrating head (17) has a vibration frequency from 20 to 40 kiloHertz.

4. Thermal screen for plastic part, comprising a reflective and thermally conductive material layer (12) and a thermally insulative material layer (11), characterized in that it is adapted to be fixed by a fixing method according to claim 1.

5. Thermal screen for plastic part, comprising a reflective and thermally conductive material layer (12) and a thermally insulative material layer (11), characterized in that it comprises at least one marking area (14) adapted to identify an area (15) of vibrational technology welding of said thermal screen (10) to a plastic part (16, 20).

6. Thermal screen according to claim 5, characterized in that said marking area (14) is an area lightly stamped in said reflective and thermally conductive material layer (12) of the thermal screen (10).

7. Thermal screen according to claim 4, characterized in that said reflective and thermally conductive material layer (12) has a thickness from 1 micrometer to 1 millimeter.

8. Thermal screen according to claim 7, characterized in that said reflective and thermally conductive material layer (12) has a thickness from 25 to 500 micrometers.

9. Thermal screen according to claim 4, characterized in that said reflective and thermally conductive material layer (12) is of aluminum.

10. Thermal screen according to claim 4, characterized in that the thermally insulative material layer (11) has a thickness from 1 to 30 millimeters.

11. Thermal screen according to claim 10, characterized in that said thermally insulative material layer (11) has a thickness from 2 to 15 millimeters.

12. Thermal screen according to claim 4, characterized in that said thermally insulative material layer (11) is a thermally insulative textile.

13. Thermal screen according to claim 12, characterized in that said thermally insulative textile layer (11) is a non-woven polyester textile.

14. Thermal screen according to claim 12, characterized in that said thermally insulative textile layer (11) is a glass fiber layer.

15. Thermal screen according to claim 5, characterized in that said reflective and thermally conductive material layer (12) has a thickness from 1 micrometer to 1 millimeter.

16. Thermal screen according to claim 6, characterized in that said reflective and thermally conductive material layer (12) has a thickness from 1 micrometer to 1 millimeter.

17. Thermal screen according to claim 5, characterized in that said reflective and thermally conductive material layer (12) is of aluminum.

18. Thermal screen according to claim 5, characterized in that the thermally insulative material layer (11) has a thickness from 1 to 30 millimeters.

19. Thermal screen according to claim 18, characterized in that said thermally insulative material layer (11) has a thickness from 2 to 15 millimeters.

20. Thermal screen according to 5, characterized in that said thermally insulative material layer (11) is a thermally insulative textile.
